(19) United States
(12) Patent Application Publication
(10) Pub. No.: US 2017/0164663 A1
(43) Pub. Date: Jun. 15, 2017

(54) Travel Pillow and Travel Cape

(71) Applicants: Carrie R. Korenek, Elmaton, TX (US); Paul Allen Korenek, Elmaton, TX (US)

(72) Inventors: Carrie R. Korenek, Elmaton, TX (US); Paul Allen Korenek, Elmaton, TX (US)

(21) Appl. No.: 15/183,079

(22) Filed: Jun. 15, 2016

Related U.S. Application Data
(60) Provisional application No. 62/265,619, filed on Dec. 10, 2015.

(51) Int. Cl. A41D 3/08; B60N 2/48; A47G 9/10

(52) U.S. Cl. CPC A41D 3/08; A47G 9/1081; B60N 2/48

(57) ABSTRACT

A travel accessory designed to provide comfort to the user during a trip contains a neck-rest, a travel cape, and an attachment mechanism. The neck-rest is removably attached to the travel cape so that the user can utilize the neck-rest and the travel cape independently. The neck-rest has a stuffing which is concealed within a hollow body of the neck-rest. The stuffing is secured in position with a fastening mechanism such as a zipper. Additionally, the neck-rest also contains a first pocket and a second pocket which are used for storing items used during travelling. For user convenience, the travel cape is designed with a first-arm receiving hole and a second-arm receiving hole. In order to transport the neck-rest and the travel cape a carrying bag is also provided. A plurality of storage pockets on the carrying bag allow the user to store items that are essential when travelling.

The current application claims a priority to the U.S. Provisional Patent application Ser. No. 62/265,619 filed on Dec. 10, 2015.

### FIELD OF THE INVENTION

The present invention relates generally to travel accessories. More specifically, the present invention introduces a pillow and a travel cape wrap which can be conveniently carried when travelling.

### BACKGROUND OF THE INVENTION

With the increased amount of travelling, the use of travel accessories has increased over time. Travelling bags, cosmetic cases, luggage straps, and travel pillows are all considered to be travel accessories. However, the present invention focusses on travel pillows which are used to support the neck of the user when travelling. Even though the existing neck pillows are efficient for short distance travelling, they might not be as effective when used for long distance travelling.

One of the main disadvantages with existing neck pillows is the limited range of motion provided to the user. In particular, when the sleeping posture of a user is different from the standard sleeping posture, using the existing neck pillows might cause discomfort mainly due to the reason that most of the existing neck pillows provide minimal support to side sleepers.

Another disadvantage with the existing neck pillows is the inability to conveniently carry the neck pillow. As seen on many occasions, the neck pillow needs to be worn around the neck when travelling or carried separately. Therefore, the need for a method of carrying the neck pillow is clearly evident.

The limited lifetime is another disadvantage with existing neck pillows. In particular, when the interior of the neck pillow loses the material properties, the entire neck pillow needs to be replaced. Over time, the need to continuously replace neck pillows can be stressful to the user.

As experienced by many individuals, the temperature in trains and planes vary significantly during a trip. Resultantly, an individual might have difficulties when travelling for long distances. Therefore, the need for a method that can keep the user stay warm during long trips is clearly understood.

The objective of the present invention is to address the aforementioned issues. In order to do so, the present invention provides a redesigned pillow and a travel cape wrap. The pillow and the travel cape wrap can be used together or separately such that the user is provided with comfort and warmth as preferred. For user convenience, the present invention also includes a carrying bag for carrying the pillow and the travel cape wrap. Since the present invention addresses the existing issues, the user is guaranteed to have a pleasurable travelling experience by utilizing the present invention.

### BRIEF DESCRIPTION OF THE DRAWINGS

FIG. 1 is an illustration of the neck-rest and the travel cape.

FIG. 2 is an illustration of the neck-rest.

FIG. 3 is an illustration of the neck-rest being attached to the travel cape.

FIG. 4 is an illustration of the attachment mechanism, wherein the attachment mechanism is a plurality of buttons.

FIG. 5 is an illustration of the attachment mechanism on the neck-rest, wherein the stuffing is illustrated within the hollow body.

FIG. 6 is an illustration of the attachment mechanism on the travel cape, wherein the attachment mechanism is the plurality of buttons.

FIG. 7 is an illustration of the fastening mechanism, wherein the fastening mechanism is a zipper.

FIG. 8 is an illustration of the attachment mechanism, wherein the attachment mechanism is a plurality of hook and loops.

FIG. 9 is an illustration of the travel cape.

FIG. 10 is an illustration of the carrying bag.

### DETAIL DESCRIPTIONS OF THE INVENTION

All illustrations of the drawings are for the purpose of describing selected versions of the present invention and are not intended to limit the scope of the present invention.

The present invention introduces a travel accessory that can be used for providing comfort when travelling for extended time periods. In particular, the present invention describes a neck pillow and a travel cape that is used to provide a comfortable travel experience to the user. Furthermore, the present invention also introduces an apparatus for carrying the neck pillow and the travel cape together.

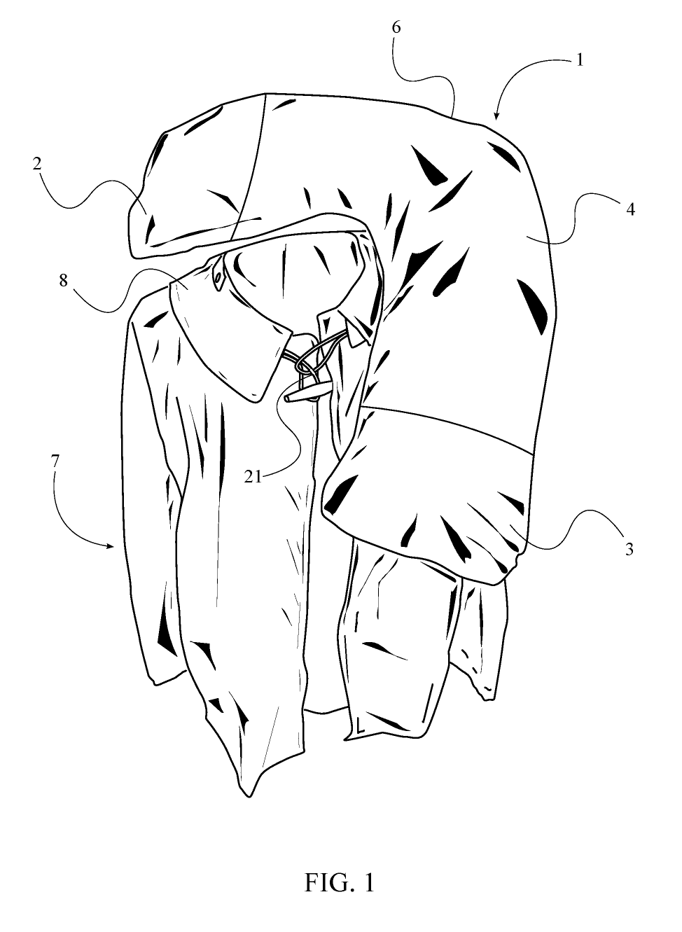

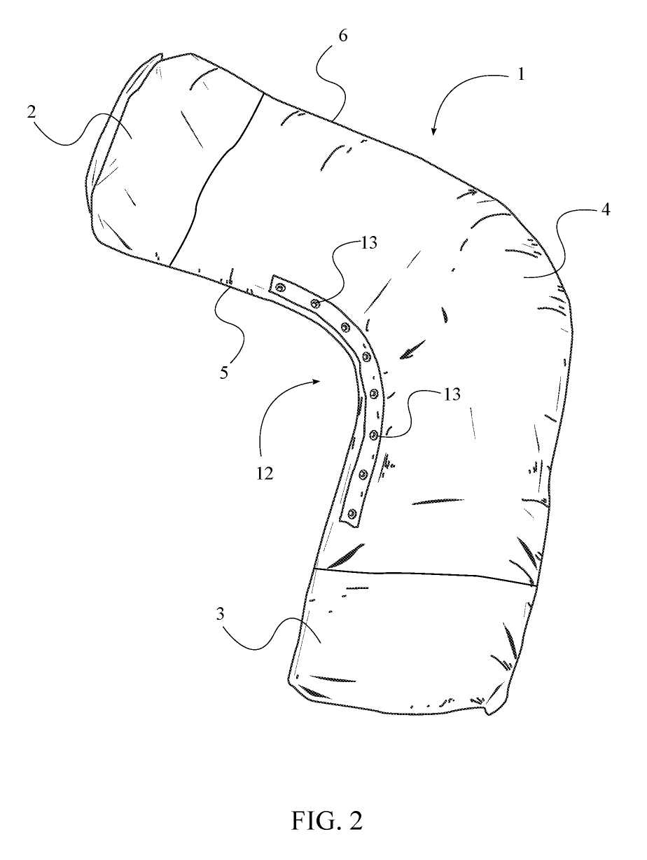

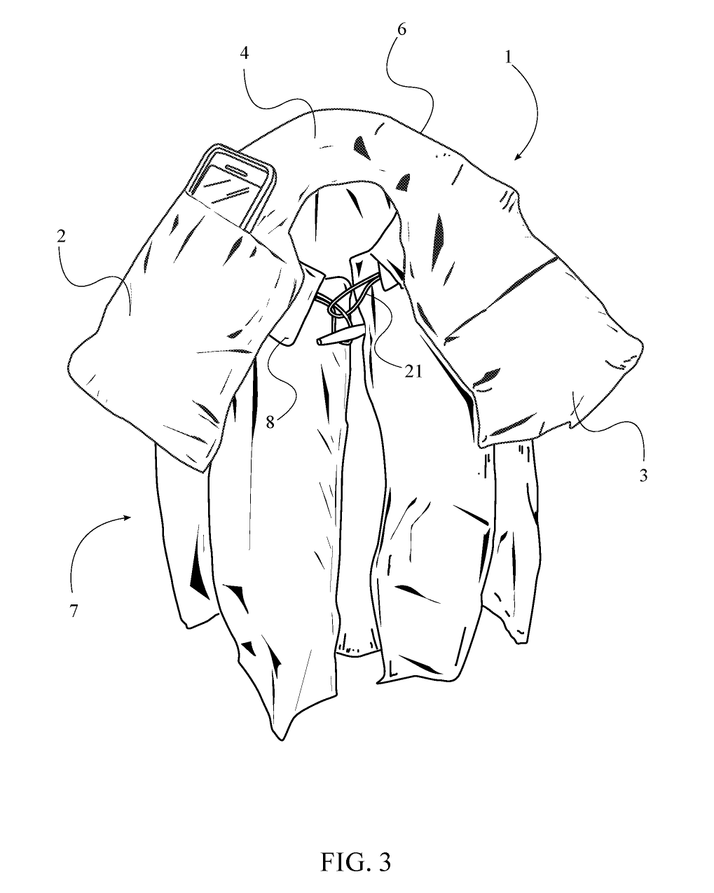

As illustrated in FIG. 1, the present invention comprises a neck-rest 1 and a travel cape 7 which can be independently used based on the preference of the user. More specifically, the neck-rest 1 can be separately used to position the head of a user. On the other hand, the travel cape 7 can be separately used to cover the body of a user. However, if the user intends on using both the neck-rest 1 and the travel cape 7, the present invention comprises an attachment mechanism 12 which is used to attach the neck-rest 1 to the travel cape 7 or vice versa. In contrast to traditional neck pillows, the neck-rest 1 comprises a first pocket 2, a second pocket 3, and a hollow body 4 as illustrated in FIG. 2. The user can use the first pocket 2 and the second pocket 3 to position their palms while sleeping. Therefore, the first pocket 2 and the second pocket 3 are especially beneficial to side sleepers. However, the first pocket 2 and the second pocket 3 can also be used to place other items that can be, but is not limited to, a mobile phone as shown in FIG. 3. In order to do so, the first pocket 2 and the second pocket 3 are integrated into the hollow body 4. The hollow body 4 defines the overall shape of the neck-rest 1. In the preferred embodiment of the present invention, the hollow body 4 comprises a concave section 5 and a convex section 6 such that the neck-rest 1 has an overall shape that helps the user rest the neck comfortably. When considering the positioning of the first pocket 2 and the second pocket 3 with the concave section 5 and the convex section 6, the first pocket 2 and the second pocket 3 traverse from the concave section 5 towards the convex section 6. Moreover, the first pocket 2 and the second pocket 3 are positioned opposite to each other about the concave section 5. In other words, the hollow body 4 is C-shaped such that the neck-rest 1 can be conveniently positioned around the neck of the user and the first pocket 2 and the second pocket 3 are on either side of the head of the user.

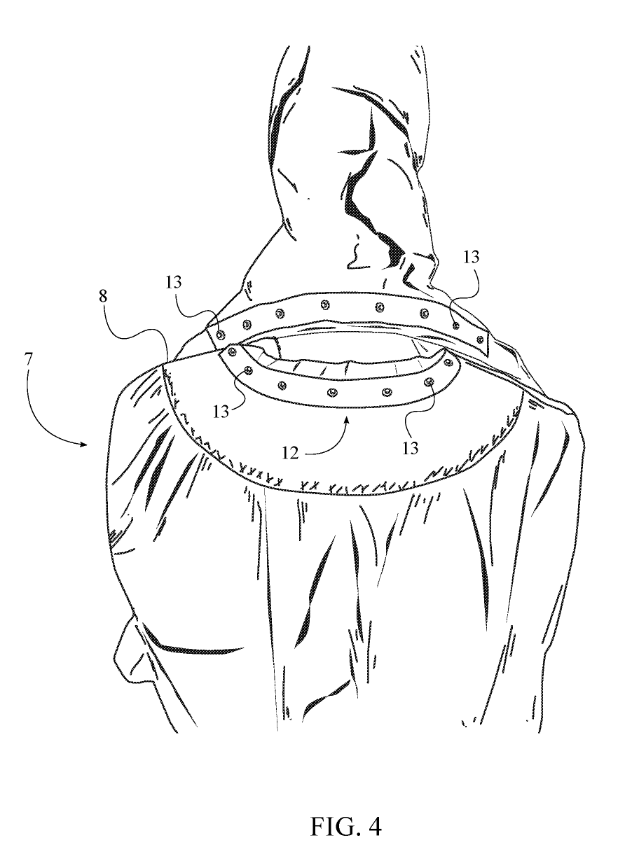

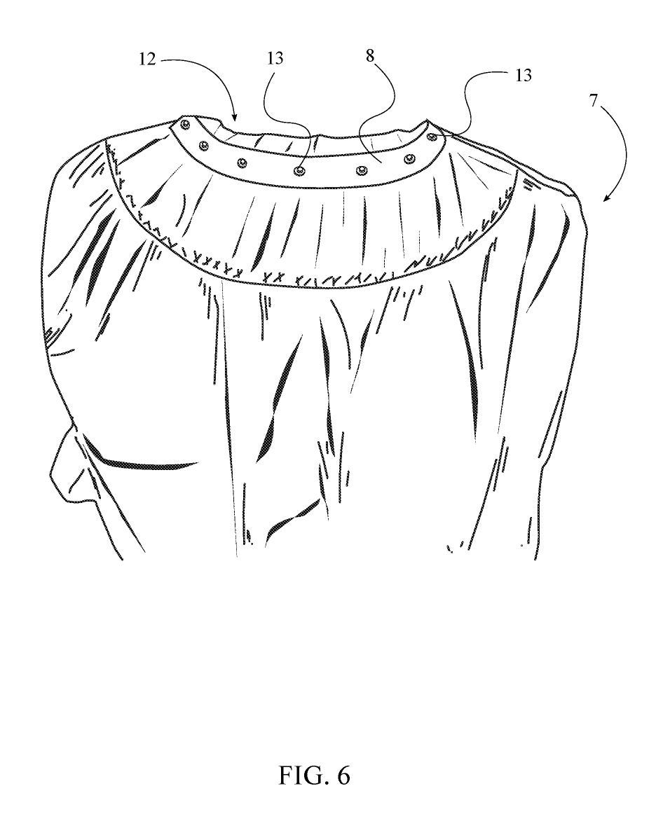

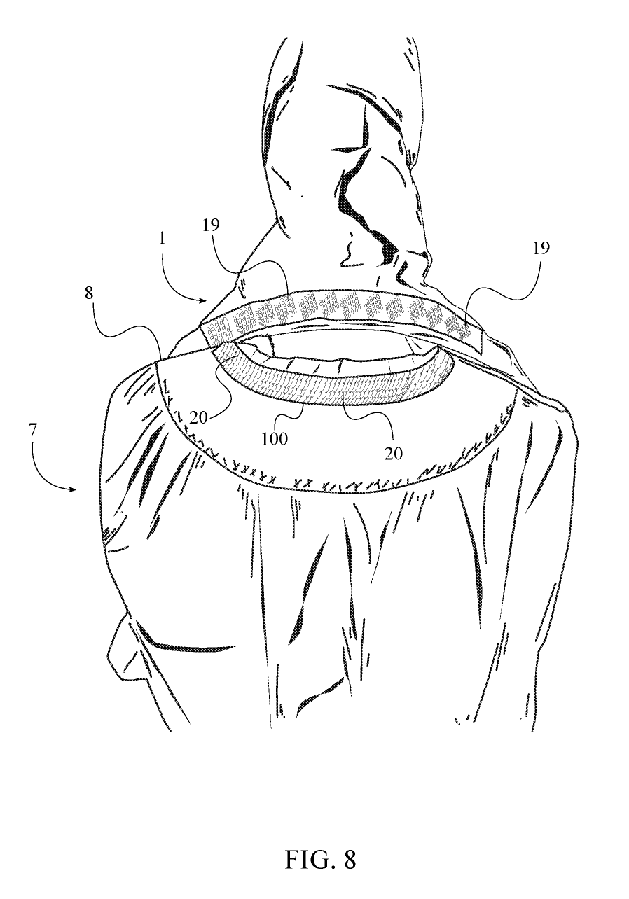

As experienced by many individuals the temperatures vary when travelling for extended time periods. The travel cape 7 is used to provide warmth and comfort to the body of the user so that the user can adjust according to the varying temperatures during the trip. As mentioned earlier, the travel cape 7 can be used along with the neck-rest 1. In order to do so, the travel cape 7 comprises a neck section 8 which is used to attach to the neck-rest 1 described earlier. More specifically, the neck-rest 1 is being removably attached to the travel cape 7 at the neck section 8 via the attachment mechanism 12 as illustrated in FIG. 4. The attachment mechanism 12, which can vary in different embodiments of the present invention, is integrated with the hollow body 4 along the concave section 5. As illustrated in FIG. 6, the attachment mechanism 12 can be, but is not limited to, a plurality of buttons 13. In another embodiment of the present invention, the attachment mechanism 12 can be, but is not limited to, a plurality of hook and loop fasteners. In such instances, the attachment mechanism comprises a plurality of hooks 19 and a plurality of loops 20 as seen in FIG. 8. The plurality of hooks 19 is connected along the concave section 5. On the other hand, the plurality of loops 20 is integrated into an external layer 100 of the neck section 8. When attached, the plurality of hooks 19 is engaged with the plurality of loops 20.

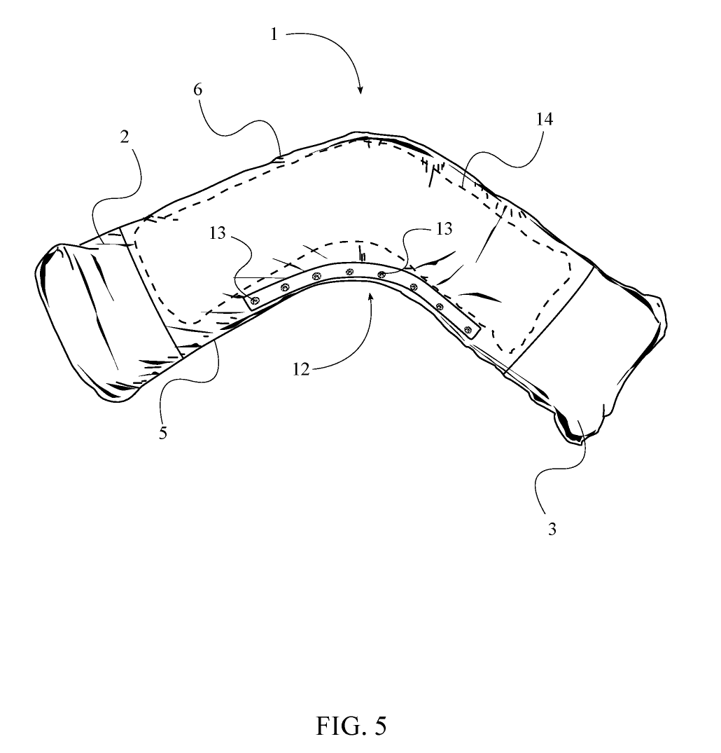

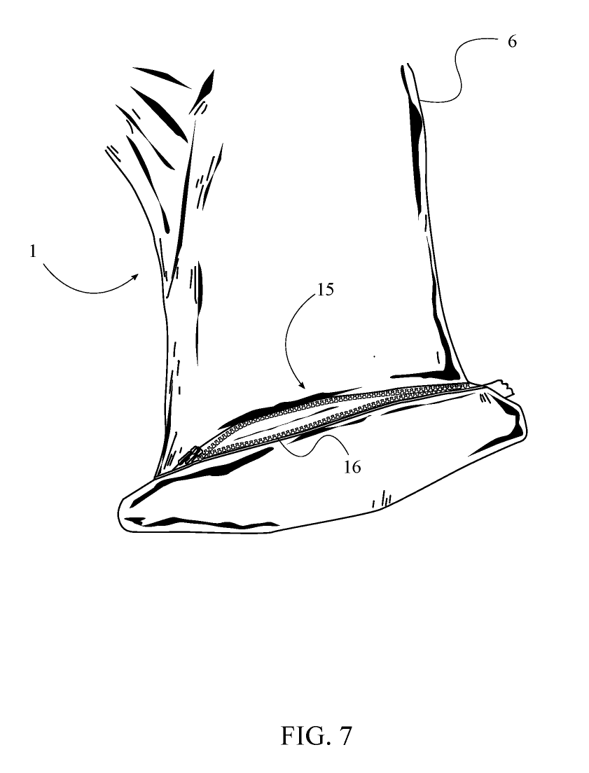

The present invention is designed to cater a wide variety of users. As illustrated in FIG. 5, the present invention is designed such that a stuffing 14, which is positioned within the hollow body 4, can be replaced as required by the user. Therefore, the user can replace or remove the stuffing 14 as necessary. This is especially important to users with allergies, since the stuffing 14 can be removed and replaced with a different stuffing which does not cause allergies. Moreover, if the need to wash the neck-rest 1 arises, the user can conveniently remove the stuffing 14 from within the hollow body 4. Also, when the material properties of the stuffing 14 wear off, the stuffing 14 can be easily replaced. The present invention comprises a fastening mechanism 15 which conceals the stuffing 14 within the hollow body 4. The fastening mechanism 15, which is integrated into the hollow body 4, can vary in different embodiments of the present invention. As illustrated in FIG. 7, the fastening mechanism 15 can be, but is not limited to, a zipper 16. Therefore, by utilizing the zipper 16 the stuffing 14 can be easily removed and then positioned within the hollow body 4.

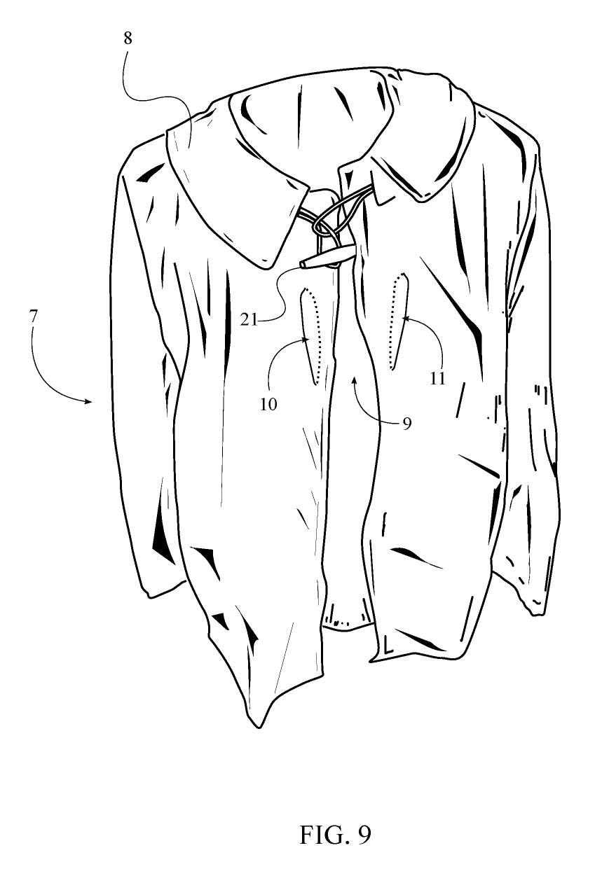

As mentioned earlier, the travel cape 7 is used to provide warmth and comfort to the body of the user. In order to do so, the present invention comprises a chest section 9, a first-arm receiving hole 10, and a second arm-receiving hole 11 as seen in FIG. 9. The first-arm receiving hole 10 and the second arm-receiving hole 11 are positioned opposite to each other across the chest section 9 and continue to extend out of the travel cape 7 allowing the user to free the arms while wearing the travel cape. As a result, the user can conveniently wrap the travel cape 7 around the body as preferred by inserting the arms into the first-arm receiving hole 10 and the second-arm receiving hole 11. The material used to manufacture the travel cape 7 can vary in different embodiments of the present invention. Therefore, the user can select from a variety of materials depending on the comfort level required. In order to keep the travel cape 7 around the body of the user, the present invention comprises an adjustable strap 21 which is positioned along the neck section 8. More specifically, the adjustable strap 21 is used to fasten the travel cape 7 around the neck of the user. The adjustable strap 21 is shown in FIG. 1.

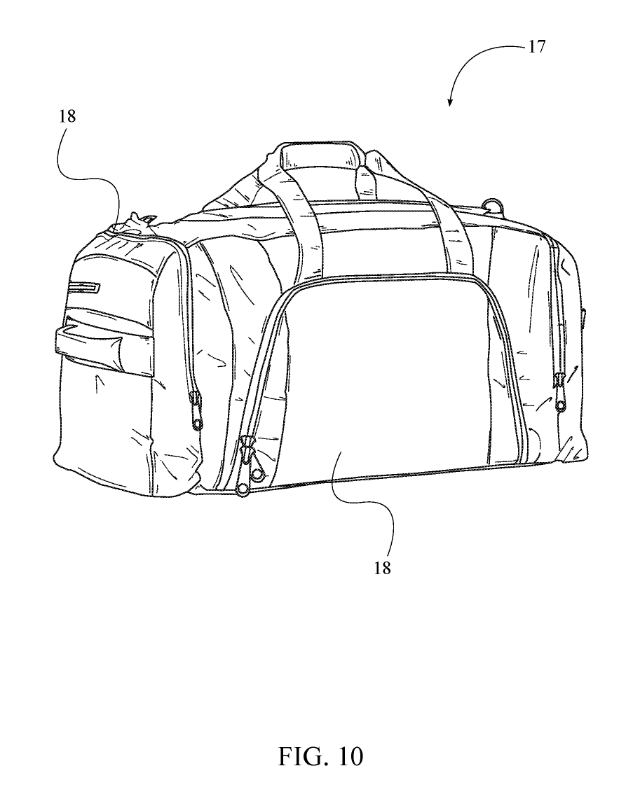

The process of carrying a travel cape and a neck pillow can be a daunting task, especially when the user has other items to carry during a trip. In order to address the issue, the present invention comprises a carrying bag 17. When the need occurs, the neck-rest 1 and the travel cape 7 are positioned within the carrying bag 17. In order to do so, the carrying bag 17 is sufficiently sized to fit the neck-rest 1 and the travel cape 7. Furthermore, the present invention comprises a plurality of storage pockets 18 which is externally positioned along the carrying bag 17 as illustrated in FIG. 10. The plurality of storage pockets 18 can be utilized to store items that are frequently used while travelling.

When utilizing the present invention, the following process flow is generally followed. As an example, if the neck-rest 1 is being used, the user positions the neck-rest 1 such that the concave section 5 is pressed against the neck of the user. When positioning the neck-rest 1 is completed, the user can position a plurality of preferred items in the first pocket 2 and the second pocket 3. In addition to storing different items that can be, but is not limited to, a mobile phone, the first pocket 2 and the second pocket 3 can also be used to position the hands of the user when sleeping. In another instance, the neck-rest 1 can be placed under the arm of a person who is breastfeeding. As a result, the arm has more support and also provides better comfort to the baby. Moreover, the neck-rest 1 can help in providing privacy during feeding. If the user intends on using the travel cape 7 along with the neck-rest 1, the travel cape 7 is attached to the neck-rest 1 at the neck section 8 via the attachment mechanism 12. Upon attaching the travel cape 7, the user inserts a first arm into the first-arm receiving hole. Next, the user inserts a second arm, to a second-arm receiving hole 11 such that the travel cape 7 can be wrapped around the body of the user. When using the neck-rest 1 and the travel cape 7 is complete, both the neck-rest 1 and the travel cape 7 can be positioned within the carrying bag 17 so that the present invention can be conveniently transported from one place to the other.

Although the invention has been explained in relation to its preferred embodiment, it is to be understood that many other possible modifications and variations can be made without departing from the spirit and scope of the invention as hereinafter claimed.

What is claimed is:

1. A travel accessory comprises:
a neck-rest;
a travel cape;
an attachment mechanism;
the neck-rest comprises a first pocket, a second pocket, and a hollow body;
the hollow body comprises a concave section and a convex section;
the travel cape comprises a neck section;
the first pocket and the second pocket being integrated into the hollow body;
the first pocket and the second pocket traversing from the concave section towards the convex section;
the first pocket and the second pocket being positioned opposite to each other about the concave section;
the attachment mechanism being integrated with the hollow body along the concave section; and
the neck-rest being removably attached to the travel cape at the neck section via the attachment mechanism.

2. The travel accessory as claimed in claim 1 further comprises:
a stuffing; and
the stuffing being positioned within the hollow body.

3. The travel accessory as claimed in claim 1 further comprises:
a fastening mechanism; and
the fastening mechanism being integrated into the hollow body.

4. The travel accessory as claimed in claim 1 further comprises:
the travel cape comprises a chest section, a first-arm receiving hole, and a second-arm receiving hole; and
the first-arm receiving hole and the second-arm receiving hole being positioned opposite to each other across the chest section.

5. The travel accessory as claimed in claim 1 further comprises:
a carrying bag;
a plurality of storage pockets;
the plurality of storage pockets being externally positioned along the carrying bag; and
the neck-rest and the travel cape being positioned within the carrying bag.

6. The travel accessory as claimed in claim 1 further comprises:
the attachment mechanism comprises a plurality of hooks and a plurality of loops;
the plurality of hooks being connected along the concave section; and
the plurality of loops being integrated into an external layer of the neck section.

7. The travel accessory as claimed in claim 6, wherein the plurality of hooks is engaged with the plurality of loops.

8. The travel accessory as claimed in claim 1, wherein the attachment mechanism is a plurality of buttons.

9. The travel accessory as claimed in claim 3, wherein the fastening mechanism is a zipper.

10. The travel accessory as claimed in claim 1 further comprises:
an adjustable strap; and
the adjustable strap being positioned along the neck section.
